(19) United States
(12) Patent Application Publication
(10) Pub. No.: US 2024/0397910 A1
(43) Pub. Date: Dec. 5, 2024

(54) LEG PROTECTOR FOR A HORSE

(71) Applicant: EVOLUTION HORSEWARE LIMITED COMPANY, Southampton (GB)

(72) Inventor: Michael LOVERIDGE, Southampton (GB)

(21) Appl. No.: 18/431,261

(22) Filed: Feb. 2, 2024

(30) Foreign Application Priority Data
May 31, 2023 (DE) 20 2023 102 976.0

(51) Int. Cl. A01K 13/00

(52) U.S. Cl. CPC A01K 13/007

(57) ABSTRACT

The present invention relates to an articulated leg protector for a horse. The leg protector comprises a plurality of shells that are movably connected to each other. Each shell has a curved cross section and is designed to partially encircle a leg of the horse. The shells define channels to receive a portion of the horse's leg and remain in place while articulating with each other as the leg moves. The shells are disposed on a flexible support and are made from a polymeric material with specific hardness and modulus properties. The shells are joined by a living hinge, with the point of articulation determining the size of the gaps between the shells. These gaps widen or narrow depending on the direction of articulation. The leg protector is designed to extend down the rear of the horse's canon bone and around the fetlock joint.

### CROSS-REFERENCE TO RELATED APPLICATIONS

This application claims priority to German Utility Model application no. 20 2023 102 976.0, filed May 31, 2023, the contents of which is incorporated herein by reference.

### TECHNICAL FIELD

The present invention relates to a leg protector for a horse. Embodiments of the present invention relate to an articulated leg protector for the front legs of a horse, and to a set of leg protectors for front and rear legs of a horse.

### BACKGROUND

When a horse walks, trots, canters or gallops, there is a risk that its rear hoofs may strike the back of its front legs, causing injury. Fabric leg protectors may be worn on the front legs to mitigate this while causing minimal restriction on movement. Hard shell leg protectors are also available which provide much greater protection against impact and injury, but at a cost of restricted leg movement.

Embodiments of the present invention seek to provide a leg protector for a horse in which the above disadvantages are avoided, or at least ameliorated.

### SUMMARY OF THE INVENTION

According to an aspect of the present invention, there is provided an articulated leg protector for a horse.

Preferably, the articulated leg protector comprises a plurality of solid/hard shells which are movably connected to each other. The shells are able to move with respect to each other, and may be directly or indirectly connected, or even be a single structure with a point of flexion enabling them to articulate relative each other.

In use, the plurality of solid shells (each) extend at least partially around a leg of the horse, the solid shells remaining in place (with respect to an underlying portion of the horse's leg) and articulating with respect to each other with movement of the leg.

In this way, by providing an articulated leg protector, and in particular by providing a plurality of hard shells which articulate with respect to each other to follow the movement of the horse's leg, the benefits of a fabric leg protector (unrestricted leg movement) and hard shell protectors (increased protection) can be achieved.

The plurality of solid shells may be disposed on flexible support material (for example a fabric, lining or other backing material), the support material generally conforming to the horses leg as it moves. Alternatively, the plurality of solid shells (or a subset of them) may be a unitary part, joined by a living hinge. The living hinge may be achieved either due to a relative narrowness (compared with the rest of the unitary part) of the joint between the two shells and/or due to a thinness of the unitary structure at a join between the two shells.

Each pair of the plurality of solid shells may be joined, abutting or most proximate each other at a point of articulation, and a gap between the shells may widen with increasing distance from the point of articulation. The gaps between the shells (away from the point of articulation) may increase in size when the leg protector articulates in a first direction, and decrease in size when the leg protector articulates in a second direction opposite to the first direction. In some cases, the gap may reduce to substantially zero at a maximum permissible articulation in the second direction, where abutment of the shells prevents or inhibits them from moving closer together.

The shells are formed from a polymeric material with a shore hardness above 40 D and an 100% modulus above 80 kg/cm² [kilogram per square centimeter].

The shore hardness is in particular above 45 D, more particularly above 50 D and in particular 55±3 D.

The 100% modulus is in particular above 90 kg/cm² and more particularly above 100 kg/cm².

The shore hardness of the polymeric material of the shells is measured by the test method defined according to ASTM D-2240.

The 100% modulus of the polymeric material of the shells is measured by the test method defined according to ASTM D-412. The 100% modulus describes the force that is required to cause a 100% elongation of the material in a tensile test, in particular in a pulling test.

It has been found out that such a material that fulfils the defined requirements regarding shore hardness and 100% modulus is particular suitable for shells of a leg protector for a horse. These shells made of this material are relatively stiff. Therefore, a good protection and guidance of the leg of the horse can be achieved. The required flexibility that allows the horse to flex its joints is achieved by the flexible connection between the different shells of the leg protector.

In use the leg protector may extend down at least a portion of the rear of the horse's canon bone and around the fetlock joint.

The articulated leg protector may comprise one or more securing components for securing the articulated leg protector onto the horse's leg. For example, straps, belts, Velcro or elasticated components may be used. While the securing means could be attached to the support material, preferably the securing components are mounted directly to the one or more shells.

The articulated leg protector may for example comprise two solid shells or three solid shells, although other numbers of shells (plural) are possible.

The articulated leg protector as described above may be for a front leg of a horse. A further leg protector may be provided for a rear leg of the horse, the further leg protector comprising a single shell having the same form as one of the solid shells of the articulated leg protector. This makes manufacturing more efficient, since the same tooling can be used for the front and rear leg protectors.

### BRIEF DESCRIPTION OF THE DRAWINGS

Embodiments of the present invention will now be described by way of example only with reference to the accompanying drawings where like parts are provided with corresponding reference numerals and in which:

FIG. 1 schematically illustrates a front leg protector for a horse, according to an embodiment of the present invention;

FIG. 2 schematically illustrates a rear leg protector for a horse, utilising some of the same parts and tooling as the front leg protector of FIG. 1;

FIG. 3 schematically illustrates side and front views of the articulated shells and underlying support of a three-part implementation of the front leg protector;

FIG. 4 schematically illustrates side and front views of the articulated shells and underlying support of a two-part implementation of the front leg protector;

FIG. 5 schematically illustrates the articulation in use of the two-part front leg protector of FIG. 4;

FIG. 6 schematically illustrates the articulation in use when applied to a horse's leg at various states of motion; and

FIG. 7 schematically illustrates the leg protector when viewed from above.

### DETAILED DESCRIPTION

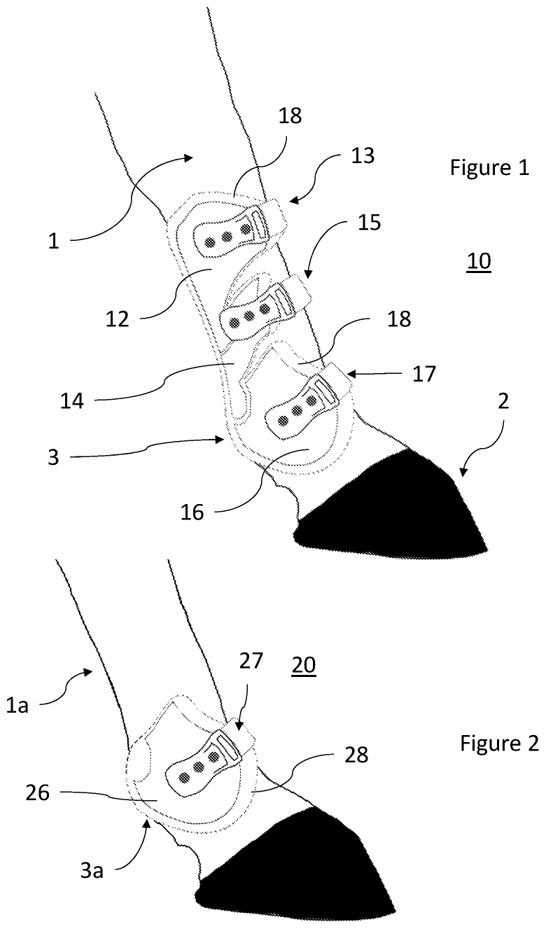

Referring to FIG. 1, a lower part of a horse's leg 1 is shown, including a hoof 2 and a fetlock joint 3. The region shown includes the horse's canon bone, which extends from the knee (not shown in FIG. 1) to the fetlock joint 3. The lower part of the canon bone, and the fetlock joint 3, are covered by a front leg protector 10. The front leg protector 10 can be seen to comprise a plurality of hard and inflexible shells 12, 14, 16, which are secured (for example stitched, glued, riveted or otherwise bonded) onto a fabric support (material) 18. The fabric support 18 is strong but flexible, and able to conform to the shape of the horse's leg 1 as the leg moves.

The fabric support 18 is a single piece of material, generally fabric, which may follow the general external outline of the first, second and third shells 12, 14, 16, but provide a small peripheral area outside of this, improving comfort for the horse. Alternatively, the fabric support 18 may take the form of a rectangle of material upon which the shells 12, 14, 16 are disposed, which wraps at least partially around the horse's leg in use. Three straps 13, 15, 17 are mounted respectively to the first, second and third shells 12, 14, 16, for securing the front leg protector 10 on the horse's leg 1. In particular the first strap 13 draws the first shell 12 into position around the horse's leg 1, the second strap 15 draws the second shell 14 into position around the horse's leg 1, and the third strap 17 draws the third shell 16 into position around the horse's leg 1. While fewer straps could be used, since the shells are movable with respect to each other, it is preferable that each shell be individually secured in place. The shells 12, 14, 16 are therefore retained in place but permitted articulation with respect to each other by virtue of their attachment via the straps, and of their attachment to each other via the support 18. The first, second and third straps 13, 15, 17 may be tightened sufficiently to prevent or at least inhibit the leg protector 10 from moving up or down the horse's leg 1 as the horse moves. In the present example, each strap is provided with a buckle to secure the strap around the leg 1, and to enable the tightness to be adjusted. It will be appreciated that a different form of securement could be used, instead of the straps and/or buckles. For example, laces could be used, or straps with clips.

In some implementations the fabric support 18 may comprise outer and inner layers, and the first, second and third shells 12, 14, 16 may be provided between the outer and inner layers. The outer and inner layers may, in effect, define pockets, for retaining the shells in the correct positions relative to each other.

In some implementations the shells may be disposed internally of the support 18, against the horse's leg. In this case additional padding may be provided inside the shells, for the horse's comfort.

Referring to FIG. 2, a rear leg protector 20 is shown. This is smaller than the front leg protector 10, and is intended only to protect the fetlock joint 3a of a horse's leg 1a. The rear leg protector 20 is not articulated, and uses only a single shell 26, attached to support 28. A strap 27 is used to secure the rear leg protector 20 in place around the horse's leg 1a, and in particular over its fetlock joint 3a. The single shell 26 of the rear leg protector 20 is the same as the third shell 16 of the front leg protector 10, and as such the same tooling can be used to manufacturer both the front (articulated) leg protector 10 and the rear (non-articulated) leg protector 20, thereby reducing manufacturing costs.

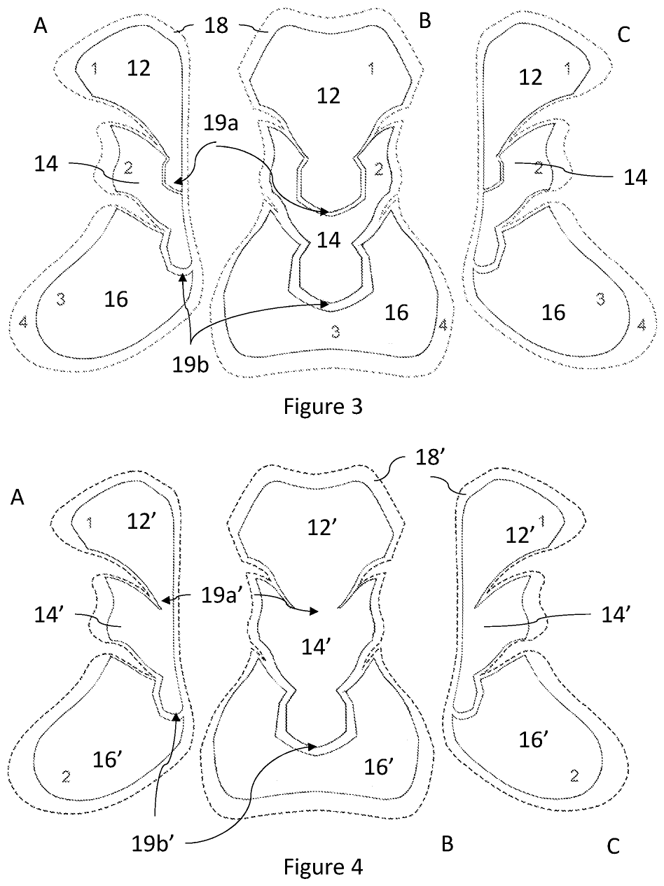

Referring to FIG. 3, three views A, B and C of the shell front leg protector 10 are shown. The views A and C show the front leg protector 10 from each side, respectively, whereas the view B shows the front leg protector from the front (the side exposed when the leg protector 10 is attached to the horse's leg 1). In FIG. 3, as with FIG. 1, the first, second and third shells 12, 14, 16 are all separate parts, connected via the underlying support 18. It can be seen that the three shells 12, 14, 16 generally tesselate (at least in part), but with gaps defined between them to permit articulation. Only a small gap is provided between the shells 12, 14 and 14, 16 in central regions 19a, 19b thereof, but the gaps increase in width with increasing distance from the regions 19a, 19b. A single support 18 is provided, which extends around the periphery of all three shells. The edges of the support 18 generally follows the outline of the shells 12, 14, 16, including following the gaps between the shells 12, 14, 16.

Referring to FIG. 4, three views A, B and C of a variation 10′ of the shells of the front leg protector 10 are shown. The views A and C show the front leg protector 10′ from each side, respectively, whereas the view B shows the front leg protector 10′ from the front (the side facing outwards from the leg 1 when the leg protector 10′ is attached to the horse's leg 1). In FIG. 4, first and second shells 12′, 14′ are defined by a single unitary part, while a third shell 16′ is separate, connected to the second shell 16 via the underlying support 18′. While the first 12′ and second 14′ shells are formed as a single unitary structure, they are still able to articulate with respect to each other, since the relatively narrow join between them in the region 19a′ acts as a living hinge. However, the amount of, and resistance to, articulation can be expected to be less than that provided between the second shell 14′ and the third shell 16′, in the region 19b′, since there is a gap between these two shells, and they are connected only via the underlying support 18′, which is more flexible and compliant than the living hinge.

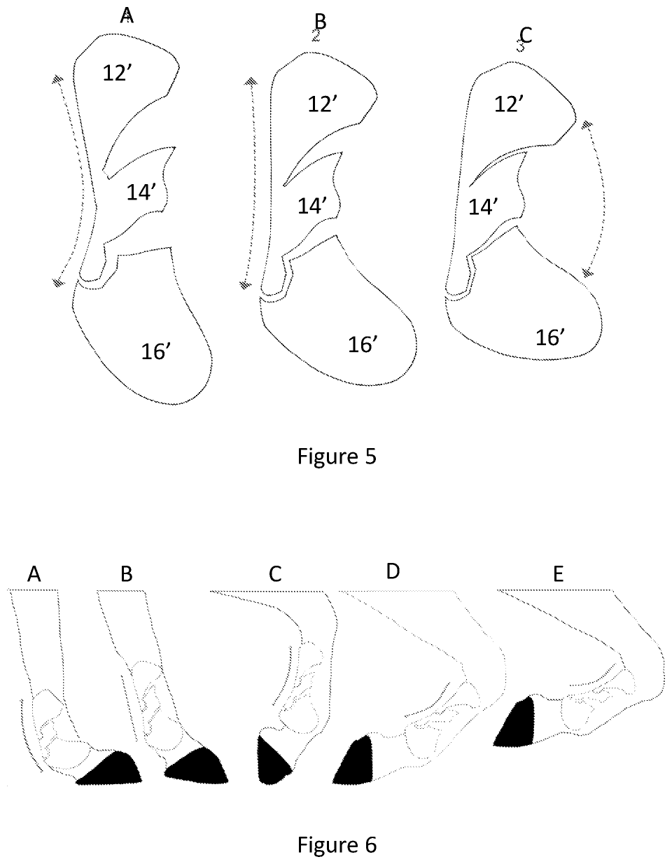

Referring to FIG. 5, the front leg protector 10′ is shown at multiple different stages of articulation, as shown by representations A, B and C. It will be appreciated that FIG. 5 would apply equally to the leg protector 10. In representation A, the leg protector 10′ is shown in a first stage of articulation, with the shells 12′, 14′, 16′ spread relatively widely apart (away from their joint with each other). That is, the gaps between the shells 12′, 14′, 16′ away from the joins are at a maximum width. In representation C, the leg protector 10′ is shown in a third stage of articulation, with the shells 12′ 14′, 16′ as close as possible. In this case, the gaps between the shells are at a minimum width (at or near zero width). In representation B, the leg protector 10′ is shown in a second stage of articulation, which is between the first and third stages. Here, the shells are a medium distance apart (compared with the extremes shown in representations A and C), and the gaps are a medium width. It will appreciated that there are an infinite number of intermediate stages between these stages, and it will also be appreciated that, depending on the precise nature of the movement of the leg (which may differ between horses), a different degree of articulation may be provided between the first shell 12′ and the second shell 14′, compared with the articulation between the second shell 14′ and the third shell 16′.

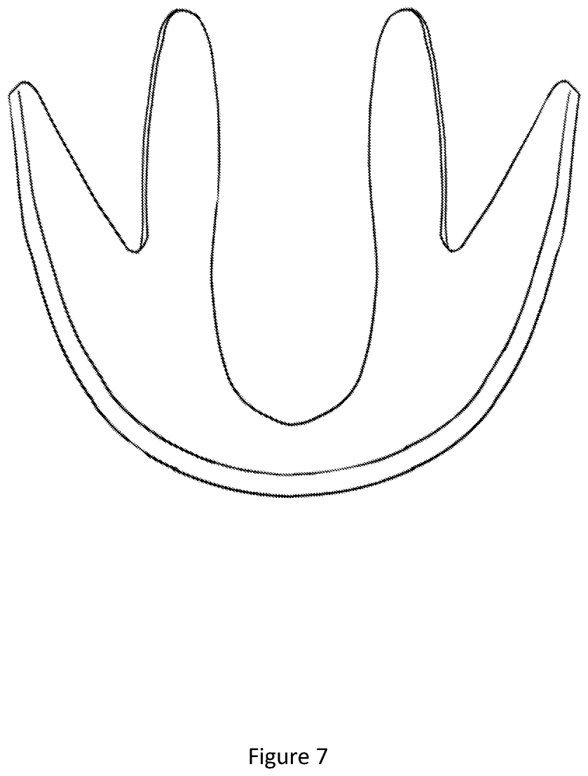

Referring to FIG. 6, the various stages of articulation of the front leg protector 10′ are shown when applied to various stages of movement of the horse's leg 1. Five stages of movement, from A to E, are shown. At stage A of FIG. 6, the horse is stood with full weight bearing on its hoof. In this position, the fetlock joint is at maximum curvature at the back of the leg, and the leg protector 10′ is at the stage C configuration shown in FIG. 5. At stage B of FIG. 6, the horse has started to remove weight from the leg, straightening up the fetlock joint, with the result that the leg protector 10′ is at the stage B configuration shown in FIG. 5. At stage C of FIG. 6, the horse has lifted its hoof, and the fetlock joint is curving the opposite direction to stage A of FIG. 6. Here, the leg protector 10′ is at the stage A configuration shown in FIG. 5. At stage D of FIG. 6, the horse's knee (hock) is partially bent and the fetlock joint has started to straighten. Here, the leg protector 10′ is between the stage A and B configurations of FIG. 5. At stage E of FIG. 6, the horse's knee (hock) is fully bent and the fetlock joint straight, and the leg protector 10′ remains generally between the stage A and B configurations of FIG. 5.

It can therefore be seen that as the horse moves its leg, and in particular as the joints and muscles move within the region covered (and protected) by the front leg protector 10′, the leg protector 10′ articulates to follow (generally conform to, or move with) those movements of the horse's leg. This maintains protection of the horse's leg without significantly restricting movement, and without pinching or squeezing the horses leg.

FIG. 7 shows an end view of the front leg protector 10 or 10′ (this would be a top down view of FIGS. 1, 3, 4 and 5). As can be seen from FIG. 7, each shell is curved, so that in use it extends around the leg 1 of the horse. In other words, at least some of the cross-sections of each of the shells 12, 14, 16, 12′, 14′, 16′ are generally U-shaped, or concave. In this way, the shells 12, 14, 16 define a plurality of open channels which can receive respective portions of the horse's leg. The open edges of the shells 12, 14, 16 are then drawn towards each other by securing elements (as shown in FIG. 1), so that the horse's leg 1 is fully received in the channels defined by the shells 12, 14, 16, and the inside of the channels are pulled inwardly towards or against the horse's leg 1.

1. An articulated leg protector for a horse, comprising a plurality of shells which are movably connected to each other, wherein the plurality of shells each have a curved cross section to extend, in use, at least partially around a leg of the horse, the shells defining channels to receive a portion of the leg of the horse, the shells remaining in place and articulating with respect to each other with movement of the leg, wherein the plurality of shells are disposed on a flexible support, the shells are formed from a polymeric material with a shore hardness above 40 D and an 100% modulus above 80 kg/cm² [kilogram per square centimeter]; the flexible support generally conforming to the horses leg as it moves, the plurality of shells being a unitary part, joined by a living hinge, wherein the plurality of shells are joined, abutting or most proximate at a point of articulation, and a gap between the shells widens with increasing distance from the point of articulation, and wherein the gaps between the shells increase in size when the leg protector articulates in a first direction, and decrease in size when the leg protector articulates in a second direction opposite to the first direction, wherein in use the leg protector extends extend down the rear of the horse's canon bone and around the fetlock joint.

2. An articulated leg protector according to claim 1, wherein the shore hardness of the polymeric material of the shells is measured by the test method defined according to ASTM D-2240.

3. An articulated leg protector according to claim 1, wherein the 100% modulus of the polymeric material of the shells is measured by the test method defined according to ASTM D-412.

4. An articulated leg protector according to claim 1, wherein the gap reduces to substantially zero at a maximum permissible articulation in the second direction.

5. An articulated leg protector according to claim 1, comprising one or more securing components for securing the articulated leg protector onto the horse's leg.

6. An articulated leg protector according to claim 5, wherein the securing components are mounted directly to the one or more shells.

7. An articulated leg protector according to claim 1, comprising two shells or three shells.

8. A set of leg protectors comprising an articulated leg protector according to claim 1 for a front leg of a horse and a further leg protector for a rear leg of the horse, wherein the further leg protector comprises a single shell having the same form as one of the shells of the articulated leg protector.
